(19) United States
(12) Patent Application Publication
(10) Pub. No.: US 2021/0229046 A1
(43) Pub. Date: Jul. 29, 2021

(54) ULTRA-THIN, HIGH-POROSITY, TRACK-ETCHED MEMBRANES

(71) Applicant: LOCKHEED MARTIN CORPORATION, Bethesda, MD (US)

(72) Inventors: Scott E. Heise, San Jose, CA (US); Lawrence William Mason, Littleton, CO (US); Jacob Louis Swett, Palo Alto, CA (US); Han Liu, Middle River, MD (US)

(73) Assignee: LOCKHEED MARTIN CORPORATION, Bethesda, MD (US)

(21) Appl. No.: 16/775,488

(22) Filed: Jan. 29, 2020

(51) Int. Cl. B01D 69/10; B01D 71/02; B01D 69/12

(52) U.S. Cl. CPC B01D 69/105; B01D 69/12; B01D 71/021

(57) ABSTRACT

Systems and methods described herein may produce a modified substrate. A process for producing a modified substrate may include providing a substrate that is 5 microns or less in thickness, ion tracking the substrate, and etching the tracked substrate with an etchant to produce a plurality of pores in the substrate. In some implementations, the substrate may be a polymer. In some implementations, the ion tracking may include controlling a flux of ions passing through the substrate to achieve a desired pore density. In some implementations, the track-etching of the substrate may create a 10% or more porosity in the substrate. In some implementations, the process may further include using the track-etched substrate as a support substrate for at least one of a single-layer graphene film, multi-layer graphene film, stack of graphene films, nanostructure of graphene flakes, or nanostructure of graphene platelets.

### FIELD

The present disclosure generally relates to modified substrates and methods for their production and, more specifically, to forming or modifying substrates that may be used to make, e.g., membranes, filters, and support substrates for 2D materials.

### BACKGROUND

Supportive substrates have found use in connection with membranes from two-dimensional materials, including graphene. Graphene may include a two-dimensional material having an atomically thin layer of carbon in which the carbon atoms reside as closely spaced atoms at regular lattice positions. Supportive substrates have also been used in connection with low-dimensional materials. These supporting substrates may be modified to have apertures, pores, topography, and/or geometries that allow them to act as stand-alone membranes or two-dimensional and/or low-dimensional material-supporting membranes with unique physical, chemical, and biological properties. Two-dimensional materials, such as graphene, as well as low-dimensional materials, may contain apertures allowing them to display selective permeability. Aside from such apertures, graphene and other two-dimensional materials and low-dimensional materials can represent an impermeable layer to many substances.

The use of substrates as stand-alone membranes, or to offer rigidity or support to layers of two-dimensional materials and/or low-dimensional materials, including graphene, may be of interest in various applications. As such, modified substrates and methods of making the same may be of considerable benefit.

### SUMMARY

Some embodiments relate to methods for producing modified substrates. The methods may include providing a substrate that may be 5 microns or less in thickness, ion tracking the substrate, and etching the tracked substrate with an etchant to produce a plurality of pores in the substrate. In some embodiments, the track-etching of the substrate may create a 10% or more porosity in the substrate. In some embodiments, providing the substrate may include providing a non-porous substrate that is 5 microns or less in thickness. In some embodiments, providing the substrate may include providing a polymer substrate. In some embodiments, providing the substrate may include providing one of a polycarbonate, a polyvinylidene fluroride, a polyimide, a polyurethane, a polyarylate, a polyethylene terephthalate, a poly(methyl methacrylate), or a polypropylene. In some embodiments, ion tracking may include controlling a flux of the ions passing through the substrate to achieve a desired pore density. In some embodiments, etching the tracked substrate may include controlling properties of the etching to achieve a desired pore size. In some embodiments, the track-etching of the substrate may create a 10 to 50% porosity in the substrate. In some embodiments, the track-etching of the substrate may create a 20 to 35% porosity in the substrate. In some embodiments, the track-etching of the substrate may create a nominal pore diameter of 10 to 2000 nm in the substrate. In some embodiments, the track-etching of the substrate may create a pore density of 1×10⁷ to 1×10¹⁰ pores per cm² in the substrate. In some embodiments, the track-etching of the substrate may create at least a 25% porosity and an average pore diameter of about 500 nm. In some embodiments, ion tracking the substrate may include covering at least a part of a surface of the substrate with an ion-absorbing mask such that non-porous regions may be maintained underneath the mask. In some embodiments, the mask may include a plurality of pores having diameters that are 5-100 times diameters of the plurality of pores of the track-etched substrate. In some embodiments, the mask may include a plurality of pores organized in a regular, repeating pattern. In some embodiments, each of the plurality of pores may have a shape, and the shapes of the plurality of pores may include at least one of a circular shape, an elliptical shape, or a polygonal shape. In some embodiments, the methods may further include using a track-etched substrate in fabrication of large-scale nanoporous or microporous membranes. In some embodiments, a track-etched substrate may be configured to be used as a high-selectivity filtration membrane. In some embodiments, a track-etched substrate may highly selectively filter a desired particulate size from 10 nm to 10,000 nm. In some embodiments, the track-etched substrate may be configured to be used in applications requiring a high-selectivity nanofiltration membrane, ultrafiltration membrane, microfiltration membrane, or semipermeable membrane.

In some embodiments, the methods may further include using the track-etched substrate as a support substrate for a two-dimensional material, a multi-layer stack or nanostructure of two-dimensional materials, a multi-layer stack or nanostructure of thin films, or a combination thereof. In some embodiments, the two-dimensional may include a single-layer graphene film, a multi-layer film, a stack of graphene films, a nanostructure of graphene flakes, or a nanostructure of graphene platelets. In some embodiments, the two-dimensional material may be or include graphene, graphene platelets, a carbon nanomembrane (CNM), carbon nanotubes (CNT), amorphous carbon and hydrocarbons, graphyne, graphane, borophene, hexagonal boron nitride (hBN), germanene, silicene, Si₂BN, phosphorene, bismuthine, molybdenite, stanine, halfnium dioxide, molybdenum disulfide (MoS₂), molybdenite, rhodium, palladium, Pb/Sn alloy, Pb/Bi alloy, aerographite, aerogel, nanogel, carbon nanofoam, borocarbonitride, transition metal dichalcogenide (TMDC), or any combination thereof. In some embodiments, the two-dimensional material (e.g., the graphene film, stack, or nanostructure) may be nanoporous. In some embodiments, the support substrate may include porous regions and non-porous regions. In some embodiments, the two-dimensional material may span the pores of the support substrate. In some embodiments, the two-dimensional material may span more than 90% of the pores in the support substrate. In some embodiments, the support substrate may further include a mesh, screen, or other permeable structure onto which the support substrate is layered, adhered, or bonded.

In some other embodiments, a system for producing a modified substrate may include means for ion tracking a substrate that is 5 microns or less in thickness, means for controlling a flux of ions passing through the substrate to achieve a desired pore density, and means for etching the tracked substrate to produce a plurality of pores in the substrate such that a desired pore size is achieved. In some embodiments, the system may further include a means for layering at least one of a single-layer graphene film, a multi-layer graphene film, a stack of graphene films, a nanostructure of graphene flakes, or a nanostructure of graphene platelets on the track-etched substrate. In some embodiments, the ion tracking means, the controlling means, and the etching means may be configured to create a 10% or more porosity in the substrate. In some embodiments, the tracking means, the controlling means, and the etching means may be configured to create a 20 to 35% porosity in the substrate. In some embodiments, the tracking means, the controlling means, and the etching means may be configured to create a nominal pore diameter of 10 to 2000 nm in the substrate. In some embodiments, the tracking means, the controlling means, and the etching means may be configured to create a pore density of 1×10⁷ to 1×10¹⁰ pore per cm² in the substrate. In some embodiments, the tracking means, the controlling means, and the etching means may be configured to create at least a 25% porosity and an average pore diameter of about 500 nm. In some embodiments, the system may further include a means for absorbing ions produced by the ion tracking means. The absorbing means may be configured to cover at least a portion of a surface of the substrate such that non-porous regions are maintained in the substrate underneath the absorbing means. In some embodiments, the absorbing means may include a plurality of pores having diameters that are 5-100 times diameters of the plurality of pores of the track-etched substrate. In some embodiments, the mask may include a plurality of pores organized in a regular, repeating pattern. In some embodiments, each of the plurality of pores may have a shape, and the shapes of the plurality of pores may include at least one of a circular shape, an elliptical shape, or a polygonal shape.

In some other embodiments, a membrane may include a two-dimensional material, a multi-layer stack or nanostructure of two-dimensional materials, a multi-layer stack or nanostructure of thin films, or a combination thereof and a support substrate onto which the two-dimensional material, stack, nanostructure, or combination is adhered. The support substrate may include a plurality of track-etched pores. In some embodiments, the support substrate may be 5 microns or less in thickness and have at least a 10% porosity from the track-etched pores. In some embodiments, the support substrate may be one of a polycarbonate, a polyvinylidene fluroride, a polyimide, a polyurethane, a polyarylate, a polyethylene terephthalate, a poly(methyl methacrylate), or a polypropylene. In some embodiments, the two-dimensional material, stack, nanostructure, or combination may be or include a graphene or a graphene-based material. In some embodiments, the two-dimensional material may be a single-layer graphene film, a multi-layer graphene film, a stack of graphene films, a nanostructure of graphene flakes, or a nanostructure of graphene platelets. In some embodiments, the two-dimensional material, stack, nanostructure, or combination may be nanoporous. In some embodiments, the two-dimensional material may be a stack of graphene films that is independently stacked on the support substrate. In some embodiments, the support substrate may have a 10 to 35% porosity. In some embodiments, the support substrate may have a 20 to 35% porosity. In some embodiments, the support substrate may have a nominal pore size of 10 to 2000 nm. In some embodiments, the support substrate may have a pore density of 1×10⁷ to 1×10¹⁰ pores per cm². In some embodiments, the support substrate may have at least a 25% porosity and an average pore diameter of about 500 nm. In some embodiments, the support substrate may include porous regions and non-porous regions. In some embodiments, the two-dimensional material, stack, nanostructure, or combination may span the pores of the support substrate. In some embodiments, at least 90% of the pores of the substrate may be spanned by the two-dimensional material, stack, nanostructure, or combination. In some embodiments, the membrane may further include a mesh, screen, or other permeable structure onto which the support substrate is layered.

In some other embodiments, a high-selectivity filtration membrane may include a porous membrane including a plurality of track-etched pores. In some embodiments, the membrane may be 5 microns or less in thickness and may have at least a 10% porosity from the track-etched pores. In some embodiments, the track-etched pores are highly selective in filtering a desired particle size. In some embodiments, the desired particle size is selected from 10 nm to 10,000 nm. In some embodiments, the porous membrane may be a support substrate for at least one of a single-layer graphene film, a multi-layer graphene film, a stack of graphene films, a nanostructure of graphene flakes, or a nanostructure of graphene platelets. In some embodiments, the membrane may be one of a polycarbonate, a polyvinylidene fluroride, a polyimide, a polyurethane, a polyarylate, a polyethylene terephthalate, a poly(methyl methacrylate), or a polypropylene. In some embodiments, the membrane may have a 20% to 35% porosity. In some embodiments, the membrane may have a nominal pore size of 10 to 2000 nm. In some embodiments, the membrane may have a pore density of 1×10⁷ to 1×10¹⁰ pores per cm². In some embodiments, the membrane may have at least a 30% porosity and an average pore diameter of about 500 nm. In some embodiments, the filter may include porous regions and non-porous regions. In some embodiments, the membrane may be cleaned, unfouled, or unclogged by using cross-flow across the surface of the membrane, by reversing the flow or pressure across the membrane, by applying electrostatic charge to repel particles, by physically wiping the surface of the membrane, or a combination of the above to remove filtered particulate and recover permeability.

### BRIEF DESCRIPTION OF THE DRAWINGS

FIG. 1 is a breach notification computer system, according to an example embodiment. FIG. 1 illustrates an image of a membrane without graphene, according to some embodiments.

FIG. 2 illustrates another image of the membrane of FIG. 1, according to some embodiments.

FIG. 3 illustrates another image of the membrane of FIG. 1, according to some embodiments.

FIG. 4 illustrates an image of a cross-section of the membrane of FIG. 1, according to some embodiments.

FIG. 5 illustrates an image of a membrane layered with a graphene film and a support mesh, according to some embodiments.

FIG. 6 illustrates an image of a cross-section of the membrane of FIG. 5, according to some embodiments.

FIG. 7 illustrates another image of the cross-section of the membrane of FIG. 5, according to some embodiments.

FIG. 8 illustrates another image of the cross-section of the membrane of FIG. 5, according to some embodiments.

FIG. 9 illustrates an image of the cross-section of the membrane of FIG. 5 from another view, according to some embodiments.

FIG. 10 illustrates an image of a membrane layered with a graphene film, according to some embodiments.

FIG. 11 illustrates another image of the membrane of FIG. 10, according to some embodiments.

FIG. 12 illustrates another image of the membrane of FIG. 10, according to some embodiments.

FIG. 13 illustrates an image of the membrane of FIG. 10 with a tear, according to some embodiments.

FIG. 14 illustrates another image of the membrane of FIG. 10 with the tear, according to some embodiments.

FIG. 15 illustrates another image of the membrane of FIG. 10 with the tear, according to some embodiments.

FIG. 16 illustrates an image of the membrane of FIG. 1 and an image of the membrane of FIG. 10, according to some embodiments.

### DETAILED DESCRIPTION

The present disclosure includes compositions, substrates, and processes for modifying a thin substrate into a porous membrane via track-etching. The porous membrane may be used as a support substrate onto which porous or non-porous graphene films or other 2D materials can be subsequently deposited. Alternatively, the substrates may be used on their own in, for example, microfiltration and nanofiltration applications requiring ultra-thin and ultra-high permeability membranes with precise size cutoffs or where the filtered particulates are readily cleanable from the membrane.

Porous membranes may be limited to membranes that are 7-25 microns thick, while, in many applications, a porous membrane less than 7 microns thick may be desirable. As an illustration, a porous graphene film may require a porous support substrate to add stability to the porous graphene film, but a membrane that is too thick may be undesirable and detract from the beneficial properties of the porous graphene film (e.g., because the thickness may decrease the permeability, flexibility and porosity of the overall material). Additionally, porous membranes may have limited porosity, for example, because increasing the porosity of the membrane beyond a certain porosity level decreases the mechanical stability of the membrane, making the membrane difficult to transport without damage. As an illustration, porous membranes may be limited to 5-15% porosity (e.g., as measured by the void spaces of a material to the total volume of the material). Yet, for some applications, a membrane with a high percentage of porosity (e.g., 10% or above porosity, 200% or above porosity, 30% or above porosity) may be desirable.

Accordingly, in one aspect, the present disclosure includes compositions, substrates, and processes for producing ultra-thin, high porosity membranes. In some embodiments, a process for producing an ultra-thin, high porosity membrane includes track etching a polymer substrate. The track etching may be performed against a first face of the substrate, against a second face of the substrate, or against both the first face and second face of the substrate.

A substrate may include a sheet of material that may be used as a stand-alone membrane, filter, or barrier. A substrate may also be used as a support upon which a two-dimensional or low-dimensional material is disposed. A substrate or substrates may include either a single layer of material or multiple layers of material adhered, bonded, or sandwiched together. In some embodiments where the substrate includes more than one layer of track-etchable material, the materials of the layers may be selected to have different etching properties.

Porous or nanoporous materials include materials having pores or channels in the micrometer or nanometer size range. The pores or channels may be substantially uniformly cylindrical or tortuous (e.g., depending on the method used to create the pores or channels). Porous and nanoporous substrates are may utilized in specific applications within medical or other fields. Such substrates may also represent a class of supporting materials upon which molecular filters, such as graphene, graphene-based materials and other two-dimensional materials, can be disposed.

Additionally, in some embodiments, an ultra-thin, highly porous membrane may be thinner than 7 microns. In some embodiments, an ultra-thin, highly porous membrane may be about 5 microns or thinner. In some embodiments, an ultra-thin, highly porous membrane may be about 3 microns or thinner. Further, in some embodiments, an ultra-thin, highly porous membrane may be 20-35% porous. In some embodiments, an ultra-thin, highly porous membrane may be at least or more than 25% porous. In some embodiments, an ultra-thin, highly porous membrane may be at least or more than 30% porous.

As noted above, in some embodiments, ultra-thin, highly porous membranes described herein may serve as support substrates for two-dimensional materials. Two-dimensional materials include those which are atomically thin, with thicknesses from single-layer sub-nanometer thickness to a few nanometers to a few micrometers, and which generally have a high surface area. In some embodiments, a two-dimensional material may have a thickness of 0.3 to 1.2 nm or 0.34 to 1.2 nm. In some embodiments, a two-dimensional material may have a thickness of 0.3 to 3 nm or 0.34 to 3 nm. In some embodiments, a two-dimensional material may have a thickness up to a few microns, such as 5 microns or 7 microns. Two-dimensional materials may be or include graphene, graphene platelets, a carbon nanomembrane (CNM), carbon nanotubes (CNT), amorphous carbon and hydrocarbons, graphene oxide, graphyne, graphane, borophene, hexagonal boron nitride, germanene, silicene, Si₂BN, phosphorene, bismuthine, molybdenite, stanine, halfnium dioxide, molybdenum disulfide, rhodium, palladium, Pb/Sn alloy, Pb/Bi alloy, aerographite, aerogel, nanogel, carbon nanofoam, borocarbonitride, transition metal dichalcogenide, or any combination thereof (see, e.g., Xu et al. (2013) “Graphene-like Two-Dimensional Materials” Chemical Reviews 113:3766-3798). Two-dimensional materials may also be or include molybdenum disulfide, boron nitride, and MXenes. Discussions of using MXenes in two-dimensional applications may be found in Pang et al., Applications of 2D MXenes in Energy Conversion and Storage Systems, 48 Chem. Soc. Rev. 72 (2019) and Anasori et al., 2D Metal Carbides and Nitrides (MXenes) for Energy Storage, 2 Nature Rev. Mater. 16098 (2017), each of which is hereby incorporated by reference in its entirety. An example of two-dimensional MXene with nanopores may be found in Mojtabavi et al., Single-Molecule Sensing Using Nanopores in Two-Dimensional Transition Metal Carbide (MXene) Membranes, 13 ACS Nano 3042 (2019), which is hereby incorporated by reference in its entirety.

Graphene includes an atomically thin layer of carbon in which the carbon atoms reside as closely spaced atoms at regular lattice positions (e.g., the carbon atoms reside within a single atomically thin sheet or a few layered sheets, such as about 20 or less, of fused, six-membered rings forming an extended sp2-hybridized carbon planar lattice). The regular lattice positions can have a plurality of defects present therein, which can occur natively or be intentionally introduced to the graphene basal plane. Such defects may also include pores, apertures, perforations, or holes. Aside from such apertures, graphene, graphene-based materials, and other two-dimensional materials can represent an impermeable layer to many substances. Therefore, the apertures in the impermeable layer of such materials can be useful for ingress and egress to an enclosure formed at least partially from the impermeable layer. Alternatively, in some embodiments, graphene (or another two-dimensional material) may be configured as a semipermeable membrane configured to allow certain substances to pass through the membrane while preventing other substances from passing through the membrane. The graphene or other two-dimensional material may be configured as semipermeable based on pore size, conductivity, reactivity, and so on.

Graphene may be used in various applications due to the favorable mechanical and electrical properties of graphene, including optical properties, thinness, flexibility, strength, conductivity (e.g., for potential electrical stimulation), tunable porosity, and permeability. For example, in its various forms, graphene may be used due to its favorable combination of high electrical and thermal conductivity values, good in-plane mechanical strength, and unique optical and electronic properties.

In various embodiments, a two-dimensional material may be or include a sheet of a graphene-based material. In some embodiments, the sheet of graphene-based material may be a sheet of single or multilayer graphene (e.g., having domains with 2 to 5 or 2 to 10 layers). In some embodiments, the two-dimensional material may be a stack of multiple sheets of single or multilayer graphene. In some embodiments, the two-dimensional material may be a nanostructure of graphene flakes or platelets (e.g., particulate pieces of graphene). For example, in some implementations, a graphene flake or platelet may be significantly smaller than a surface feature that the flake or platelet is being used to cover (e.g., many platelets and flakes may be in the micron size range). Platelets and flakes may be used interchangeably, or a platelet may be an exclusively two-dimensional material, while a flake may have at least some three-dimensional structure. In some embodiments, the sheet of graphene-based material may include a plurality of interconnected single or multilayer graphene domains. In some embodiments, the interconnected domains may be covalently bonded together to form the sheet. When the domains in a sheet differ in crystal lattice orientation, the sheet is polycrystalline.

A domain may include a region of a material where atoms are uniformly ordered into a crystal lattice. A domain may be uniform within its boundaries but different from a neighboring region. For example, a single crystalline material has a single domain of ordered atoms. In some embodiments, at least some of the graphene domains may be nanocrystals, having domain size from 1 to 100 nm or from 10 to 100 nm. In some embodiments, at least some of the graphene domains may have a domain size greater than 100 nm to 1 micron, or from 100 nm to 800 nm, or from 300 nm to 500 nm. In some embodiments, at least some of the graphene domains may have a domain size up to 1 mm or more. Grain boundaries may be formed by crystallographic defects and represent edges of each domain differentiated from neighboring crystal lattices. In some embodiments, a first crystal lattice may be rotated relative to a second crystal lattice by rotation about an axis perpendicular to the plane of a sheet, such that the two lattices may differ in crystal lattice orientation.

In some implementations, graphene-based materials may include, but are not limited to, single-layer graphene (“SLG”), few-layer graphene (“FLG”), multilayer graphene, or interconnected single or multilayer graphene domains, and combinations thereof. In some embodiments, graphene-based materials may also include materials that have been formed by stacking single or multilayer graphene sheets. In some embodiments, multilayer graphene may include 2 to 20 layers, 2 to 10 layers, or 2 to 5 layers. In some embodiments, graphene may be the dominant material in a graphene-based material. For example, a graphene-based material may include at least 20% graphene, at least 30% graphene, at least 40% graphene, at least 50% graphene, at least 60% graphene, at least 70% graphene, at least 80% graphene, at least 90% graphene, or at least 95% graphene. In some embodiments, a graphene-based material may include a range of graphene selected from 30% to 95%, from 40% to 80%, from 50% to 70%, from 60% to 95%, or from 75% to 100%.

In some implementations, FLG or multi-layered graphene includes multiple sheets of graphene formed by independently layering or stacking as-synthesized sheets of graphene on a substrate. Independently as-synthesized sheets that have been layered or stacked on a substrate may be termed “independently stacked.” Adjacent graphene layers formed by independent stacking can be less ordered in the z-direction than as-synthesized multilayer graphene. In examples, independently stacked adjacent layers may not display A-B, A-B-A, or A-B-C-A stacking. In additional examples, there may be no defined registry of adjacent layers of independently stacked graphene. In an embodiment, layers of as-synthesized sheets of graphene that have been stacked in this fashion may be less ordered in the z-direction (e.g., the lattices of the sheets may not line up as well as layers in an as-synthesized multilayer graphene sheet). However, in some embodiments, by transferring as-synthesized sheets of graphene such that they are independently stacked, the resulting layers of graphene may not experience the same defects as as-synthesized multilayer graphene. For example, a first sheet of graphene may have a defect in a first location (e.g., created during the synthesizing process or during the transfer process), and a second sheet of graphene may have a defect in a second location. However, because the first sheet of graphene and the second sheet of graphene are independently stacked, the defects may not overlap.

Suitable as-synthesized sheets may include sheets of SLG, sheets of bi-layer graphene (“BLG”), or sheets of FLG (e.g., up to 5 layers of graphene). For example, when a “float down” transfer technique is used, a sheet of SLG may be layered via float-down on top of a substrate. Another sheet of the SLG may then be floated down on the already prepared SLG-substrate stack, forming two layers of as-synthesized SLG on top of the substrate. This can also be extended to an FLG or a mixture of SLG and FLG. Additionally, independently stacked layers can be achieved through other transfer methods known in the art, such as stamp methods.

In some embodiments, a number of layers may refer to the number of separate layers of transferred graphene. Further, in some embodiments, a layer of transferred graphene may have a range of graphene layers (e.g., some regions of the layer may be SLG and others may be BLG or FLG), and the stack may accordingly have a range of graphene layers. For example, if each of five layers of transferred graphene has one to five layers, then regions where the five sheets line up with five layers effectively have twenty-five layers of graphene. As such, depending on the perforation conditions, the thicker regions of the stack may not perforate. In some embodiments, layering of different sheets of graphene may result in a membrane for filtration and separation applications, and the membrane may be tailored through the layering.

However, two-dimensional materials are not limited to graphene and graphene-based materials. Other nanomaterials having an extended two-dimensional molecular structure can also constitute the two-dimensional material in some embodiments. As such, ultra-thin, highly porous membranes may be used as support substrates for non-graphene two-dimensional materials, such as graphene oxide, hexagonal boron nitride, molybdenum disulfide, graphyne, graphene, germanene, borophene, borocarbonitrides, silicene, stanine, molbdenite, TMDCs, nanogels, aerogels, and/or nanofoams. Additionally, in some embodiments, ultra-thin, highly porous membranes may be used to support heterogeneous combinations of graphene and non-graphene two-dimensional materials, such as stacks of graphene and hexagonal boron nitride, and/or heterogeneous combinations of non-graphene two-dimensional materials, such as stacks of hexagonal boron nitride and molybdenum disulfide.

In some implementations, a two-dimensional material may be or include molybdenum disulfide or boron nitride. For example, molybdenum disulfide may serve as a two-dimensional material based on its being a representative chalcogenide having a two-dimensional molecular structure. Further, other various chalcogenides can constitute the two-dimensional material. In some implementations, a two-dimensional material may be or include boronitride, which may be capable of being broken down by a patient's body and therefore be advantageous in applications where the two-dimensional material is implanted in a patient.

Additionally, in some embodiments, ultra-thin, highly porous membranes may be used as support substrates for other thin materials, such as thin films or other coatings. In some embodiments, a thin film includes a film, membrane, or other coating of a monolayer of a material up to 10-100 nm of a material (e.g., a two-dimensional material or a low-dimensional material). For example, in some implementations, a thin film may be too thin to support itself. Moreover, in some embodiments, ultra-thin highly porous membranes may be used as support substrates for alternative configurations of thin materials, such as a multi-layer stack or a nanostructure of two-dimensional materials, nanofibers, nanotubes, gels, or other thin films and coatings. In some embodiments, ultra-thin, highly porous membranes may also be used as support substrates for combinations of materials, such as a combination of two-dimensional materials, multi-layer stacks of two-dimensional materials and/or thin films, and/or nanostructures of two-dimensional materials and/or thin films.

Further, in some embodiments, ultra-thin, highly porous membranes may be used as support substrates for low-dimensional materials. Low-dimensional materials include those that are molecularly thin and that generally have a high surface area. In some embodiments, a low-dimensional material may have a thickness of 10 nm up to 100 nm or hundreds of nm (e.g., up to 1 micron). Low-dimensional materials may be or include at least some of the same substances used to create two-dimensional materials, such as graphene or a graphene-based material. In some embodiments, low-dimensional materials may be or include flexible organic compounds, SiO₂, electrospun nanofibers, thin meshes of carbon nanotubes, or cross-linked networks of polymers. For example, a low-dimensional material may be a carbon that is molecularly thin rather than on the nanoscale.

Huang et al., Ultrathin Carbon Molecular Sieve Films and Room-Temperature Oxygen Functionalization for Gas-Sieving, 11 Appl. Mater. Interfaces 16726 (2019), which is hereby incorporated by reference in its entirety, describes an example of a low-dimensional material: carbon molecular sieve (“CMS”) films on the order of 100 nm used for gas separation. As another example, Neumann et al., Bottom-Up Synthesis of Graphene Monolayers with Tunable Crystallinity and Porosity, 13 ACS Nano 7310 (2019), which is hereby incorporated by reference in its entirety, describes a technique for preparing porous graphene sheets, where the average width of the graphene sheets ranged from 156±91 nm and the average width of the pores ranged from 79±46 nm. Yang et al., Large-Area Graphene-Nanomesh/Carbon-Nanotube Hybrid Membranes for Ionic and Molecular Nanofiltration, 364 Science 1057 (2019), which is hereby incorporated by reference in its entirety, describes, as another example of a low-dimensional material, a porous single-layer graphene nanomesh (“GNM”) supported by an interwoven network of single-walled carbon nanotubes (“SWCNs”).

A process for producing ultra-thin, highly porous membranes may include track etching a membrane, which may be described as follows according to some examples. To begin with, an ultra-thin substrate may be obtained. In some embodiments, the substrate may be separately fabricated (e.g., using well-known fabrication methods for the substrate). In some embodiments, the substrate may employ a roll of polymer film stock, such as Kapton® 12EN film. In some embodiments, the substrate may have a thickness of 7 microns or less. In some embodiments, the substrate may have a nominal thickness of about 5 microns or less. In some embodiments, the substrate may be made from a polymer, such as a polycarbonate, a polyvinylidene fluoride (“PVDF”), a polyimide, a polyurethane, a polyarylate, polyethylene terephthalate (“PET”), poly(methyl methacrylate) (“PMMA”), or polypropylene (“PP”). The polymer may be selected based on how the polymer reacts to etching, as well as other properties of the polymer (e.g., the T_{g} of the polymer, which may affect whether and how the polymer may be sterilized; the biocompatibility of the polymer; the hydrophilicity of the polymer; etc.) As an example, the substrate used may be a roll of polyimide film stock with a thickness of about 3 microns. Additionally, in some embodiments, the substrate may be non-porous. Alternatively, in some embodiments, the substrate may already be porous, and the track etching process described below may be used to increase the porosity of the substrate.

Once the ultra-thin substrate is obtained, sensitized tracks may be produced through the ultra-thin substrate. A track may include a modified zone or acts of creating a modified zone along a trajectory of energetic particles (e.g., ions) passing through sensitive materials, which may include a substrate. In some embodiments, the source of the ions must have enough energy to cause the ions to penetrate the substrate and may include multiple escape windows to create an ion beam used to irradiate the substrate. For example, in some embodiments, the ultra-thin substrate may be irradiated using an alpha and fission source, a cyclotron, a nuclear reactor, a heavy ion particle accelerator, or other source of high energy ions. When the ultra-thin substrate is irradiated with the high-energy ion source, the ion particles leave a damage track through the substrate by damaging chemical bonds.

The tracks may then be widened into cylindrical pores by treating the substrate with a caustic etchant. Etching may include contacting the substrate with an etchant to texture or perforate the substrate. Etching may form pores or perforations throughout the thickness of the substrate, imparting the substrate with selective permeability. In some embodiments, the caustic etchant reacts with the tracks to selectively etch out the tracks into cylindrical pores (e.g., by etching out the ion tracks faster than the rest of the material). In some implementations, any suitable etchant reactive with tracks in the substrate may be used. For example, NaClO or NaOH may be used as the etchant for a polyimide substrate. The etchant may be a single basic or acidic solution or a combination of basic or acidic solutions. For example, other etchants may include K₂CO₃, KMnO₄ with NaOH, KMnO₄ with H₂SO₄, or CrO₃ with H₂SO₄. Additionally, to etch the tracks into cylindrical pores, either face of the ultra-thin substrate may be contacted with etchant while the other is not, or both faces of the ultra-thin substrate may be contacted with etchant.

In some implementations, parameters of the track etching process may be varied to produce a different pore density and/or pore size in the ultra-thin substrate. Pore density may be modified by controlling the flux of the ions passing through the substrate. For example, pore density may be changed by varying the thickness and/or density of the ion beam, by varying the amount of time the substrate is exposed to the ions, by varying the number of exposures of the substrate to the ions, and so on. In some embodiments, controlling the flux of ions may be done through the source of high energy ions itself (e.g., as a function, mode, etc. of the source), or controlling the flux of ions may be done using another device or technique. As an example, an ion beam may be narrowed through a lens to form a smaller beam such as a microbeam. Pore size may be modified by controlling properties of the etching process. For example, pore size may be changed by varying the type of etchant used, by varying the concentration of the etchant used, by varying the temperature of the etching process, by varying the time of the etching process, and so on. As an illustration, pore size may vary roughly linearly based on the amount of time used for the etching process. Pore size may also be affected by controlling the flux density of ions because the more ions the substrate is exposed to, the more likely it is that the substrate will include areas with multiple close or overlapping ion tracks, thereby creating larger pores when those areas are etched. Additionally, in some embodiments, a membrane with desired properties may be fabricated through multiple parameter variations. As an example, using a first etchant concentration at a first temperature may produce a membrane with the same or roughly the same pore size as using a second, lower etchant concentration at a second, higher temperature.

As an illustration of the track etching process described above, a 1.5 to 3 micron, non-porous, polyimide film may first be obtained. The polyimide film may then be irradiated until a track density of 2×10⁸ tracks/cm⁻² is obtained. Next, the polyimide film may be etched using NaClO at 6% concentration for thirty minutes at 75° C. to obtain pores with a pore diameter, on average, of about 500 nm. In some examples, this may result in a porosity of up to 35% (e.g., plus or minus a certain amount of error or standard deviation). However, in other examples, a different porosity may be achieved, such as a porosity of at least approximately 25%. For example, a porosity of 30-35% with an average pore diameter of 1 micron may be achieved. Additionally, the porosity achieved may depend on the average pore size. For example, as the average pore size increases, the maximum pore size that can be achieved without sacrificing structural integrity may decrease.

In some embodiments, the ultra-thin substrate may be patterned during the track etching process by covering at least part of the surface of the substrate with an ion-absorbing mask during the irradiation step of the track-etching process. Because the mask prevents ions from reaching the substrate, non-porous regions are maintained underneath the mask. In this way, precisely delineated porous and non-porous regions may be created in the substrate, which may increase the handleability of the material and/or optimally pattern the porous regions to meet the needs of the application for the ultra-thin substrate. Different types of desired patterns may be used based on the application for the substrate. For example, the mask may include pores that are organized in a regular repeating patterns. The pores may have shapes that include, but are not limited to, circles, elliptical shapes, polygonal shapes, and combinations thereof. Additionally, in some implementations, a mask may be used to pattern the substrate in such a way that the pattern increases the robustness of the substrate. For example, track-etched portions of a substrate may be weaker than non-track-etched portions of the substrate, and a pattern (e.g., a grid pattern, hexagonal array, or other geometric pattern or non-regular shape, such as long slits or a serpentine shape) may be used to create robust, non-porous regions between weaker, porous regions of the substrate. Further, in some implementations, pores of the mask used to pattern the substrate may be much larger than pores of the track-etched substrate. For instance, the mask pores may have diameters that are 5-100 times the diameters of the pores of the track-etched substrate.

The mask may be any material capable of blocking ions from reaching a substrate (e.g., by absorbing the ions, by rejecting the ions), such as a metal. In some embodiments, the material used for the mask may depend on the thickness of the ions used in the tracking process. In some embodiments, the mask may be a microscale mask with spacing between and/or size of porous regions ranging from the nm-scale or μm-scale to the mm-scale (e.g., from 100 nm to 5 mm). As an example, the track-etching process may produce holes in the membrane based on the fact that the irradiation process is stochastic such that some areas of the membrane may receive close or overlapping tracks that, when etched, become holes. A microscale mask may be used to tailor the pore density by absorbing ions in microscale areas, thus minimizing the chance of holes occurring. This may, in turn, maintain the porosity of the overall membrane while maintaining the membrane's durability. In some embodiments, the spacing of the mask may be configured to optimize the total area of porous to non-porous regions (e.g., at least 33% and less than 50% porous regions).

Additionally, the mask may be selected based on the desired porosity and mechanical properties for a membrane. In some embodiments, the type of mask may be selected based on the average pore diameter for the membrane (e.g., to ensure that the mask is at least an order of magnitude larger than the average pore diameter). In some embodiments, the type of mask may be selected based on expected stresses of the macrostructure of the membrane. For example, a larger scale mask may be selected for a membrane expected to undergo larger expected stresses such that the microstructure provides better resistance for those stresses. In some embodiments, the type of mask may be selected based on a desired porosity for the membrane, particularly as the size of the mask may result in a trade-off between mechanical properties and porosity. As an example, a larger scale mask may decrease the overall porosity of the membrane, while providing better mechanical properties to the membrane, and vice versa for a smaller scale mask. However, by using a mask to increase the mechanical properties for the membrane, the porosity of the etched areas may be increased without compromising the overall structural integrity of the membrane. To illustrate, a membrane etched with a mask may have an overall porosity of 30%, but because the mask provides better mechanical properties to the membrane, the porosity of the etched areas may be up to 50%.

Furthermore, in some embodiments, because the membrane may be more likely to rip in porous areas, using a mask during the track-etching process may provide rip-stop properties to the resulting membrane; the non-etched areas may prevent the membrane from ripping, or make it more difficult to rip the membrane, past the non-etched areas. As such, the type (e.g. pattern and size) of the mask may be selected based on desired rip-stop properties for the membrane. For example, a mask with a circle pattern or a hexagonal pattern may provide good rip-stop properties. Moreover, the type of mask may be selected based on a combination of the above desired properties for the membrane. As an illustration, a hexagonal mask may be selected for the membrane because the hexagonal pattern provides good rip-stop properties and tessellates well and also increase the mechanical strength of the membrane.

In some embodiments, a membrane produced by the processes described above may have a nominal thickness of 1-5 μm. Additionally, in some embodiments, a membrane produced by the processes described above may have a pore density of 1×10⁴ to 1×10¹⁰ pores per cm² and a nominal pore diameter of 10-100,000 nm. In some implementations, a membrane produced by the processes described above may have a pore density of 1×10⁷ to 1×10¹⁰ pores per cm² and a nominal pore diameter of 10-2000 nm. In some other implementations, a membrane produced by the processes described above may have a pore density of 1×10⁴ to 1×10⁷ pores per cm² and a nominal pore diameter of 2000-100,000 nm. In some embodiments, a membrane produced by the processes described above may have pores on the same scale as the thickness of the membrane (e.g., one or more microns).

In some embodiments, membranes produced through the processes described above may be ultra-thin and highly porous, with a smooth, flat surface and sharply defined, cylindrical micropores. The combination of ultra-thinness and high porosity may result in a membrane having very high or maximum permeability with a precise pore size cutoff and without tortuous pore paths present in other types of membranes. Moreover, a membrane produced through the processes described above may include high permeability combined with a minimal pressure drop across it due to its extreme thinness, which may be advantageous over other permeable membranes regardless of the membrane's use as a standalone membrane (e.g., for microfiltration) or as a support membrane (e.g., for a two-dimensional material or low-dimensional material).

For example, a membrane produced through the processes described above may serve as a support substrate for two-dimensional (2D) materials or low-dimensional materials (e.g., a support substrate for nanoporous graphene), be used in the fabrication of large-scale nanoporous or macroporous membranes (e.g., 1 cm², 10 cm², 100 cm², or larger scale) from 2D materials, or be used in high-efficiency particulate filtration (e.g., Martian dust filtration). In some embodiments, membranes produced using the processes described above may be used in conjunction with other membranes or films (e.g., nanoporous graphene) to create high-performance membranes that may be used in difficult filtration or mass transport environments, such as to create biocompatible nanomembranes for cell encapsulation.

As an illustration, fabricating ultra-thin, high porosity membranes may weaken the membranes to the point that such membranes may not be commercially transported and, as such, not commercially available. In some implementations, porous membranes may be limited to 7-8 microns in thickness, while the ultra-thin, high porosity membranes disclosed herein may be 5 microns or less in thickness. Additionally, while membranes may be generally limited to 5-15% porosity, the membranes created using the processes described herein may be 10-35% porous. In some examples, the membranes may be 20-35% porous or may be 30-35% porous.

In some embodiments, the smoothness of track-etched membranes may make them ideal as supports for two-dimensional materials and/or low-dimensional materials. Additionally, high-permeability support substrates are necessary to unlock or realize the potential extreme permeability of porous two-dimensional materials, as a composite membrane (e.g., a track-etched support membrane and the porous two-dimensional material layered on top of the membrane) can never be more permeable than the least permeable element of the composite membrane. As an illustration, atomically thin materials and low-dimensional materials (e.g., materials around 10 nm thick) may need to be supported due to their thinness. The membranes produced according to the processes described above may be thin but with good porosity and good mechanical properties. As such, the membranes may be used as supports for materials at least an order of magnitude smaller than the membranes, such as atomically thin and low-dimensional materials, without significantly decreasing the porosity of these materials. For example, a porous, one-micron thick membrane may be used as a support for a porous, 10 nm-thick, low-dimensional material, with the membrane having pores that are sized to minimize obscuration of the pores of the low-dimensional material by the membrane while maximizing the number of pores covered by to the low-dimensional material. Thus, the membrane may not significantly decrease the porosity of the low-dimensional material.

In some embodiments, the track-etched membranes may further be functionalized. For example, active molecules may be covalently bonded to a track-etched membrane, such as through covalent bonds or weaker bonds like hydrogen bonding, to functionalize the membrane. In some embodiments, linker molecules may be used to facilitate the attachment to active molecules, or the surface of the track-etched membrane may be modified to facilitate the bonding with the active molecules. The functionalization may be used to promote biocompatibility of the membranes, alter the stiffness of the membranes, alter the charge of the membranes, alter the texture of the membranes, and so on.

Illustrative active molecules used to functionalize track-etched membranes may include gold nanoparticles, fibrosis-reducing drugs, and zwitterionic materials. An example of functionalizing using gold nanoparticles (specifically, IL-4-conjugated gold nanoparticles) may be found in Raimondo & Mooney, Functional Muscle Recovery with Recovery with Nanoparticle-Directed M2 Macrophage Polarization in Mice, 16 Proc Nat'l Acad Sci 10648 (2018), which is hereby incorporated by reference in its entirety. An example of using anti-inflammatory drugs (specifically, long-term delivery of anti-inflammatory drugs and drugs blocking the monocyte and macrophage-expressed colony stimulating factor 1 receptor (“CSF1R”)) may be found in Farah et al., Long-Term Implant Fibrosis Prevention in Rodents and Non-Human Primates Using Crystallized Drug Formulations, 18 Nat Mater 892 (2019), which is hereby incorporated by reference in its entirety. An example of using a zwitterionic material (specifically, a zwitterionic hydrogel formed from an oppositely charged alginate and poly(ethylene imine)) may be found in Zhang et al., Rapid and Long-Term Glycemic Regulation with a Balanced Charged Immune-Evasive Hydrogel in T1DM Mice, 29 Adv Funct Mater 1900140 (2019), including the Supporting Information, which are hereby incorporated by reference in their entireties. It should be understood, however, that these articles illustrate exemplary active molecules that may be used to functionalize track-etched membranes but do not necessarily include the same delivery mechanisms that would be used to functionalize the track-etched membranes discussed herein. For example, covalent bonding of the active molecules to the track-etched membrane may be used rather than bonding or releasing the active molecules from a hydrogel. In some embodiments, an active molecule may be incorporated into the track-etched membrane (e.g., before the track etching process) such that it disrupts a two-dimensional lattice of the membrane.

Other active molecules for increasing functionalization may include small molecules, cytokines, and proteins, which may be used with the membrane to alter the patient's immune response to the membrane. As another example of functionalization, a track-etched membrane may be modified to alter the change on a membrane to increase its biocompatibility (e.g., giving the membrane a negative charge). As a further example of functionalization, the texture of a membrane may be modified to change its immunocompatibility.

As an illustration of the above, a track-etched membrane may be functionalized with proteins (or molecules that the patient's body will identify as proteins). The proteins may help isolate the membrane from macrophages by making the membrane “look” to immune cells like it is part of the patient's body, by encouraging local immunosuppression, and/or by interacting with the patient's immune system causing a favorable immune cascade (e.g., making the membrane appear like a wound to the immune system to cascade the immune system into promoting vascularization and wound healing around the membrane).

Functionalization may be provided to track-etched membranes through various known methods. For example, active molecules may be adhered to the membrane by dipping the membrane in the active molecules or by spraying the active molecules onto the membrane. As further examples, roll-on lithography or embossing may be used to provide functionality to the membrane. In some embodiments, track-etched membranes may be modified or functionalized as discussed in U.S. patent application Ser. No. 16/218,859, entitled “Modified Track-Etched Substrates for Composites for Graphene Membranes,” filed Dec. 13, 2018, which is hereby incorporated by reference in its entirety.

Additionally, functionalization may be provided before or after the track etching process. For example, functionalization to a membrane may be provided (e.g., by modifying the membrane to include active molecules) before track-etching to ensure that the areas of the membrane between the pores are functionalized but the pores remain non-functionalized, as long as the functionalization process does not interact with the etchant. Functionalization may be provided after track-etching (e.g., by dipping the membrane in active molecules) to ensure that all areas of the membrane, including the outside edges of the pores, are functionalized. Further, in some embodiments, the track-etched membranes may be cleaned with silver nitrate after being functionalized, for example, to promote sterility in the membranes. The track-etched membranes may also be functionalized on one or both sides of the membrane according to various embodiments. As an illustration, a track-etched membrane for a biological application, such as implantation in a human body, may be functionalized on one side to be biocompatible and functionalized on the other side to interface with a two-dimensional material. The functionalization may be temporary or permanent. For example, the track-etched membrane may be coated with a permanent coating or with a temporary coating configured to be consumed (e.g., consumed locally for immunosuppression).

As noted above, in some implementations, membranes produced according to the processes described above may serve as support layers for two-dimensional materials, such as graphene. Graphene may be used in various applications due to its favorable mechanical and electrical properties, including optical properties, thinness, flexibility, strength, conductivity (e.g., for potential electrical stimulation), tunable porosity, and permeability. In some embodiments, the graphene may also be porous (e.g., nanoporous due to track etching the graphene). Nevertheless, graphene may be delicate enough that it must be layered with a support substrate in order to be used in some applications. However, some support substrates may lessen the advantageous properties of the graphene due to, for example, their thickness or limited porosity. As such, ultra-thin, high porosity membranes produced according to the processes described may be advantageous because they may be thinner, more flexible, smoother, and/or more porous and thus help preserve the advantageous properties of the graphene in the overall layered material. For example, in some implementations, an ultra-thin, highly porous membrane produced according to the processes described above may have pore sizes large enough that the nanoporous graphene spans the pores of the membrane (e.g., at least 90% of the pores of the substrate). Thus, the membrane may ensure that a large amount of the graphene's surface area is exposed, and, if the graphene is porous, that the porosity of the membrane is not the limiting factor in terms of the porosity of the overall graphene material. Similar applications may be made for other, porous, non-graphene two-dimensional materials (e.g., a hexagonal boron nitride two-dimensional material) and/or porous low-dimensional materials for which the track-etched membranes serve as support layers.

In some embodiments, the track-etched membrane may range from 100 nm to 1 micron in thickness, with the graphene or other two-dimensional or low-dimensional material at least an order of magnitude lower in thickness. In some embodiments, the track-etched membrane may range from 10 nm to 100 nm in thickness, with the graphene or other two-dimensional or low-dimensional material at least an order of magnitude lower in thickness. The thickness of the track-etched membrane and the two-dimensional or low-dimensional material used may depend on the application for the membrane and material combination. For example, protein sizes may range from 20 to 100 nm, and cells may be on the order of 100 nm. As such, a two-dimensional or low-dimensional material may be selected with a thickness and/or pores configured for the size of the biological application, and the thickness of the track-etched membrane may be a complementary thickness.

Alternatively, the track-etched membranes may themselves be layered with a support layer or substrate. For example, a support substrate may be selected that has a similar or greater porosity to the track-etched membranes described herein such that the membrane layered with the support substrate forms a hierarchical structure that is open and thin.

The method of attaching a material, such as a two-dimensional material, a low-dimensional material, or a support substrate, to the track-etched membrane may depend on the thickness of the membrane. For example, a two-dimensional material may be attached to the track-etched membrane through Van der Waals forces or by placing water between the membrane and the two-dimensional material to facilitate attachment through hydrogen bonding. A low-dimensional material may be attached to the track-etched membrane through covalent bonding. Additionally, the layered material may be separated from the track-etched membrane by a support layer as described, for example, in U.S. patent application Ser. No. 16/218,859, entitled “Modified Track-Etched Substrates for Composites for Graphene Membranes,” filed Dec. 13, 2018, which was incorporated by reference in its entirety above. Further, the layered material may also be functionalized using the processes described above. For example, the track-etched membrane may be layered with a graphene material including a stealth coating (e.g., to make the graphene material difficult for the patient's immune system to detect).

In some embodiments, the track-etched materials may be used by themselves without another layered material. As an illustration, ultra-thin, highly porous membranes produced according to the processes described above may be configured for use in applications requiring a high-specificity nanofiltration, ultrafiltration, or microfiltration membrane or a semipermeable membrane. In some embodiments, a high-specificity filter may include a filter that has a discrete size cutoff and/or the percentage of larger particles passing through the filter is very low, with “nanofiltration,” “ultrafiltration,” and “microfiltration” referring to the size cutoff of the particle that is being filtered. For example, in some implementations, nanofiltration membranes may filter approximately 0.001 to 0.01 μm particles, ultrafiltration membranes may filter approximately 0.01 to 0.1 μm particles, and microfiltration membranes may filter approximately 0.1 to 1.0 μm particles. Accordingly, ultra-thin, highly porous membranes produced according to the processes described above may be configured for any of these applications because the pore size and porosity can be tailored (e.g., between 10 nm to a few μm, or even smaller with the addition of a two-dimensional material). Additionally, these ultra-thin, highly porous membranes may be more efficient in filtration due to their thinness, precise size cutoff, and unique suitability for use with two-dimensional materials. Furthermore, these ultra-thin, highly porous membranes may be tailored for use in a variety of applications due to the ability to make high-specificity filters across a large range of filtration cut-off sizes (e.g., 10 nm to 10,000 nm), as discussed above.

For example, as noted above, in some implementations, ultra-thin, highly porous membranes produced according to the processes described above may serve as high-permeability particle filters, such as filters for dust filtration. Some existing filters may be unsuitable or undesirable for fine particle filtration because, in being fabricated to filter down to the required particle size, the filters lose permeability. Accordingly, such filters may be capable of filtering down to the required particle size but may be slow or inefficient at filtration, or even unusable, by not allowing enough desired substances (e.g., air) through the filter. By contrast, membranes produced according to the processes described herein may be ultra-thin and ultra-porous such that they may be used for fine particle filtration but still maintain desired permeability. Moreover, the track-etched pores may have discrete sizes for a tight filter size cutoff

Many existing filters may also be single-use because they may lack the necessary mechanical properties to be cleaned. By contrast, membranes produced according to the processes described above may be fabricated such that they stop a particulate at the membrane surface, making them readily cleanable, and are sturdy enough to be cleaned. For example, in some embodiments, ultra-thin, highly porous membranes may be cleaned, unfouled, or unclogged by using cross-flow across the surface of the membrane, by reversing the flow or pressure across the membrane, by applying electrostatic charge to repel particles, by physically wiping the surface or the membrane, or a combination of the above to remove filtered particulates and recover permeability. Furthermore, membranes produced according to the processes described herein may be more tolerant to clogging due to the less tortuous pore paths, and their pore sizes may be tailorable to unique filtration requirements.

### Examples of Ultra-Thin, High Porosity Membranes

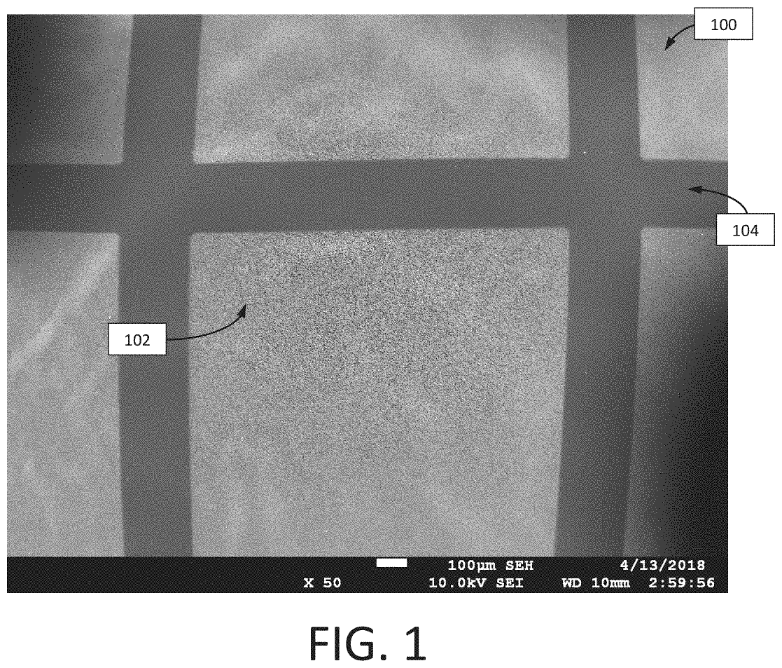

FIGS. 1-16 illustrate various images of ultra-thin, high porosity membranes taken using a scanning electron microscope (“SEM”). FIG. 1 shows an image of an example ultra-thin, high porosity membrane 100 fabricated according to the processes described above. The membrane 100 is magnified fifty times in FIG. 1. As shown in FIG. 1, the membrane 100 includes regions 102 that were left uncovered during the track-etching process and thus include a large number of pores. Additionally, the membrane 100 includes regions 104 that were covered with a mask (e.g., a metal mesh) during the track-etching process and are thus non-porous. In some implementations, the membrane 100 may be fabricated as shown in FIG. 1 because the porous regions 102 provide the membrane with high porosity, while the pattern of the non-porous regions 104 provide robustness to the membrane 100. It should be understood, however, that while the pattern of porous regions 102 shown in FIG. 1 is a grid pattern, other patterns may be used, such as a hexagonal array pattern or another geometric pattern.

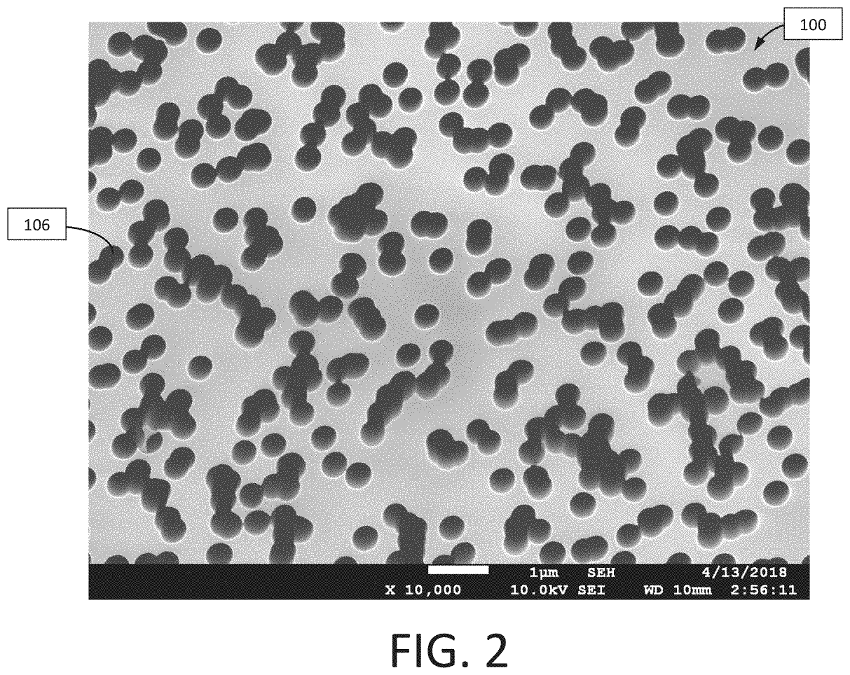

FIG. 2 shows another image of the example membrane 100 and, specifically, where the membrane 100 has been magnified 10,000 times. As shown in FIG. 2, the individual pores 106 of the porous regions 102 can be seen at this magnification. In some implementations, and as illustrated in FIG. 2, the track-etching process described above may create a membrane 100 with well-defined, non-tortuous pores 106. However, because the irradiation portion of the track-etching process is random, some of the pores 106 overlap each other, thus creating larger holes through the membrane 100. Additionally, at least some pores 106 may be elliptical or slightly elliptical in shape due to the ion tracks not being perfectly normal to the surface of the membrane 100. As described above, in some embodiments, the amount of these larger holes may be minimized by controlling the flux of ions through the membrane or by placing a micromask on the membrane 100 before the membrane 100 is irradiated during the track etching process.

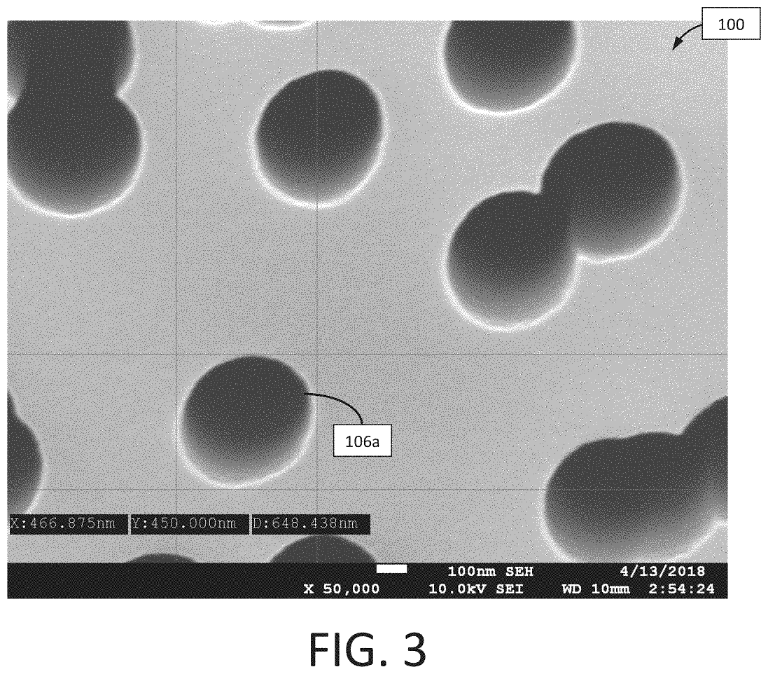

FIG. 3 shows another image of the example membrane 100 and, specifically, where the membrane 100 has been magnified 50,000 times. The image of the example membrane 100 shown in FIG. 3 includes measurements relating to the pore 106a. The pore 106a is shown to have an x-dimension of approximately 467 nm and a y-dimension of approximately 450 nm. Thus, the pore 106a has a diameter of about 450-475 nm. Moreover, as shown by the difference in x-dimension and y-dimension measurements of the pore 106a, at least some pores 106 may be slightly elliptical. However, it should be understood that in some implementations, pores of an ultra-thin, highly porous membrane fabricated according to the processes described herein may be of different sizes. For example, as described above, the pore size may be varied by modifying the etchant used in the track-etching process, by modifying the etching time, by modifying the etching temperature, and so on.

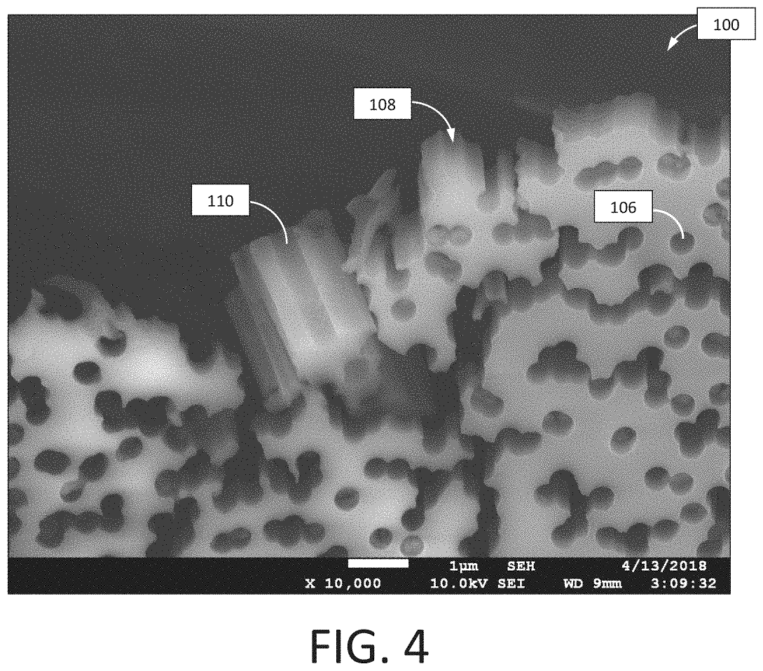

FIG. 4 shows an image of the example membrane 100 illustrating a cross-section 108 of the membrane 100 exposed after the membrane 100 was intentionally ripped. The membrane 100 is shown as magnified 10,000 times and has a thin cross-section (e.g., about 3 microns). As illustrated in FIG. 4, the cross-section 108 of the membrane 100 includes cross-sections 110 of the pores 106 extending through the width of the membrane 100. As shown, the cross-sections 110 of the pores 106 may extend straight through the width of the membrane 100 and may not be tortuous. Additionally, and as further shown in FIG. 4, the pores 106 may be cylindrical in shape.

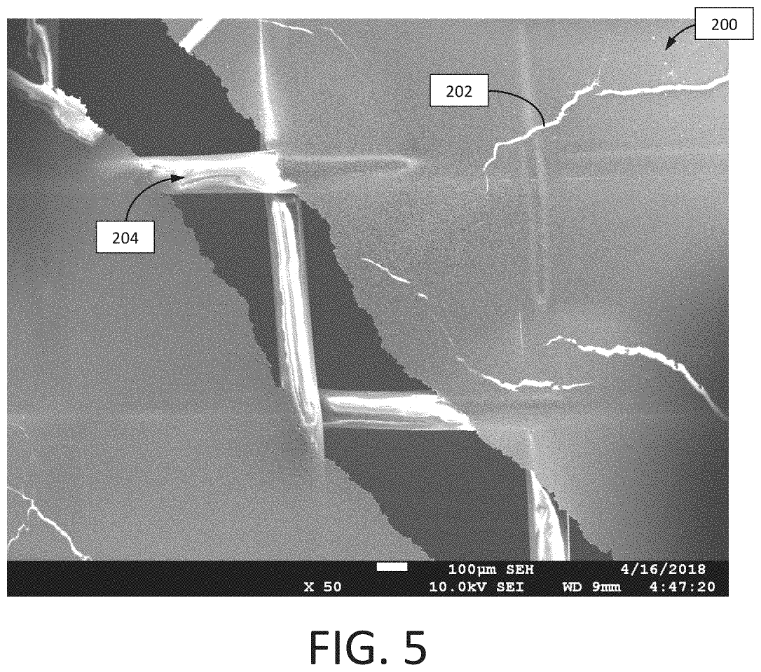

FIG. 5 shows an image of another example ultra-thin, high porosity membrane 200 fabricated according to the processes described above. Specifically, the membrane 200 is magnified fifty times in FIG. 5. Unlike the membrane 100 shown in FIGS. 1-4, however, the membrane 200 does not include masked/non-porous regions and has been layered with a graphene film on top and a support mesh 204 on the bottom. It should be understood, however, that while FIGS. 5-7 show the membrane 200 as layered with a support mesh, other permeable support structures may be used, such as screens. In some embodiments, the graphene film may be bonded to the membrane 200 through van der Waals forces. The graphene film is highly conductive and thus cannot be directly observed at lower magnifications at images produced with an SEM, such as the image shown in FIG. 5, which uses an electron beam to image a surface. However, in any places where the graphene film is broken, the underlying membrane 200 will build up an electromagnetic charge under the electron beam and appear bright white. As such, the graphene film can be indirectly observed through the bright white microtears 202 shown in FIG. 5.

In some embodiments, membranes produced according to the processes described herein may be strong given their relative thinness (e.g., 3 microns or less) and be self-supporting but may also not be stiff (e.g., may have a feel similar to a plastic wrap). As such, layering a membrane with a support mesh, screen, or other highly open support may add stiffness, handleability, and durability to the membrane. In the example of FIG. 5, the support mesh 204 is a fine, woven fiber mesh used to support the membrane 200. The support mesh 204 may be observed through a tear intentionally introduced in the membrane 200 to show the support mesh 204 underneath.

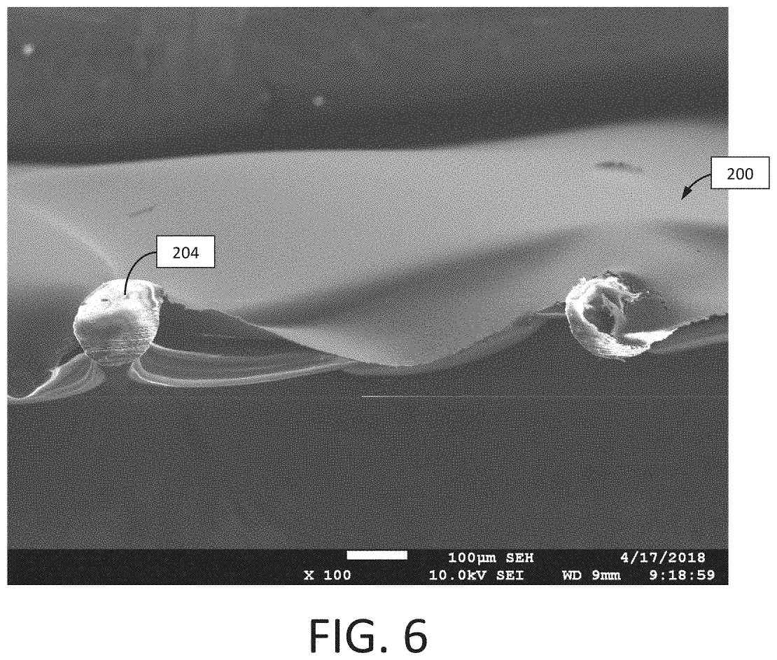

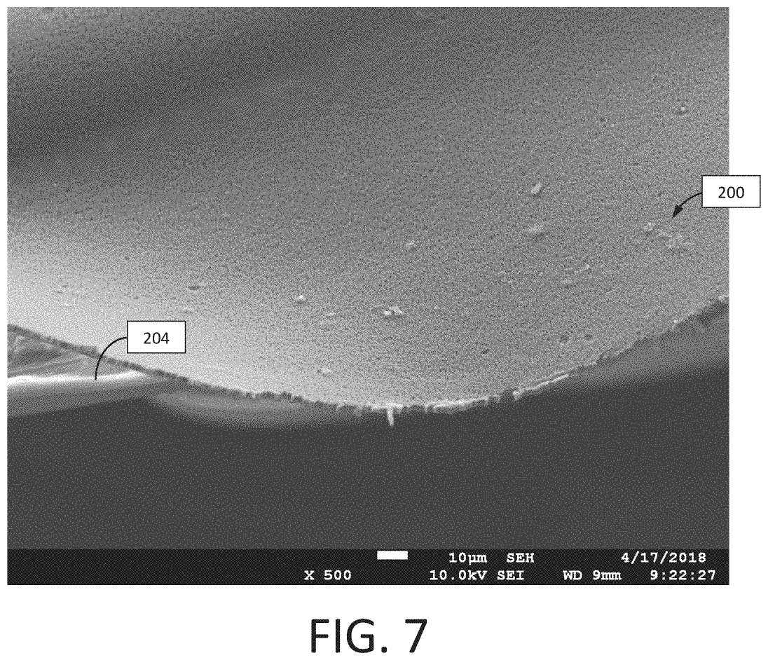

FIG. 6 shows another image of the example membrane 200 illustrating a cross-section of the membrane 200. Specifically, the membrane 200 as shown in FIG. 6 is magnified 100 times. FIG. 7 shows another image of the example membrane 200 along the cross-section but at the magnification of 500 times. As illustrated in FIGS. 6 and 7, the membrane 200 has the strength to span the mm-sized gaps between fibers of the support mesh 204 and accommodate the undulations in the surface of the woven support mesh 204.

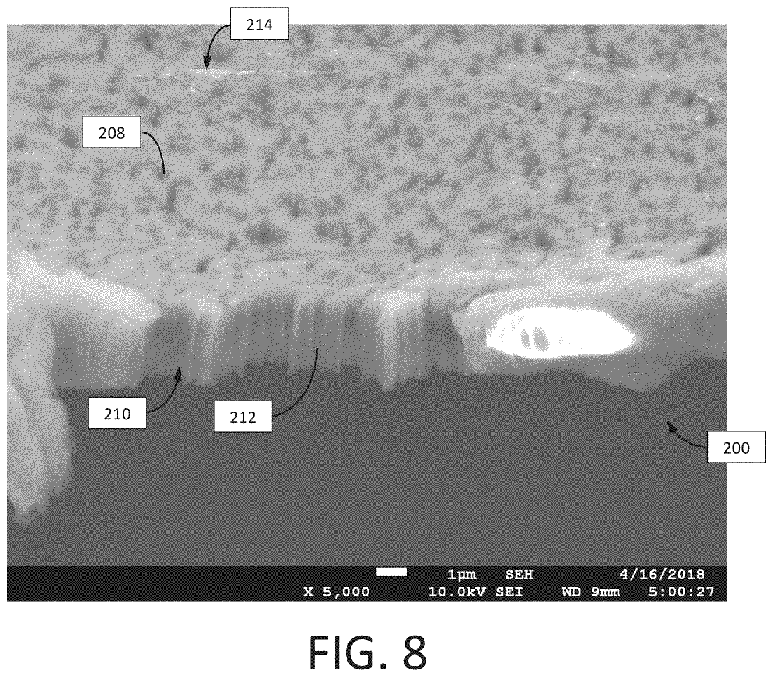

FIG. 8 shows another image of the example membrane 200, specifically, where the membrane 200 is magnified 5,000 times. As shown in FIG. 8, individual pores 208 of the membrane 200 can be distinguished, as can the cross-section 210 of the membrane 200. As further shown in FIG. 8, and similar to the membrane 100 illustrated in FIG. 4, the cross-section 210 of the membrane 200 includes cross-sections 212 of the pores. As shown, these cross-sections 212 may again extend straight through the width of the membrane 200 and may be cylindrical. Furthermore, the graphene film can again be indirectly observed in FIG. 8 through undulations 214 in the graphene film observable at this magnification.

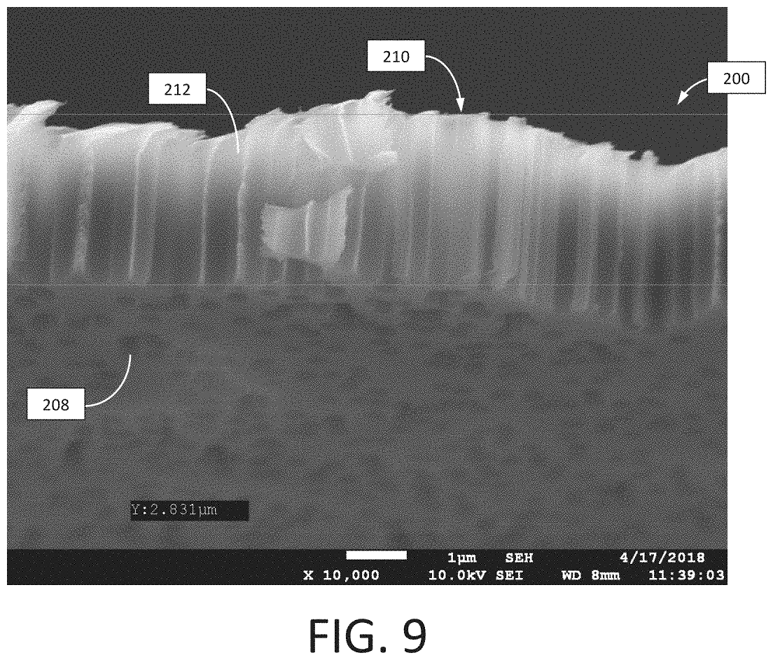

FIG. 9 shows another image of the example membrane 200 from a different view of the cross-section 210 of the membrane 200 and magnified 10,000 times. Thus, the well-defined, cylindrical cross-sections 212 of the pores 208 may be further observed in FIG. 9. Additionally, FIG. 9 further includes a measurement of the cross-section 210 of the membrane 200, shown to be approximately 2.8 microns in thickness. It should be understood, however, that the width of the membrane 200 is an example width and that other membrane widths are possible in other embodiments.

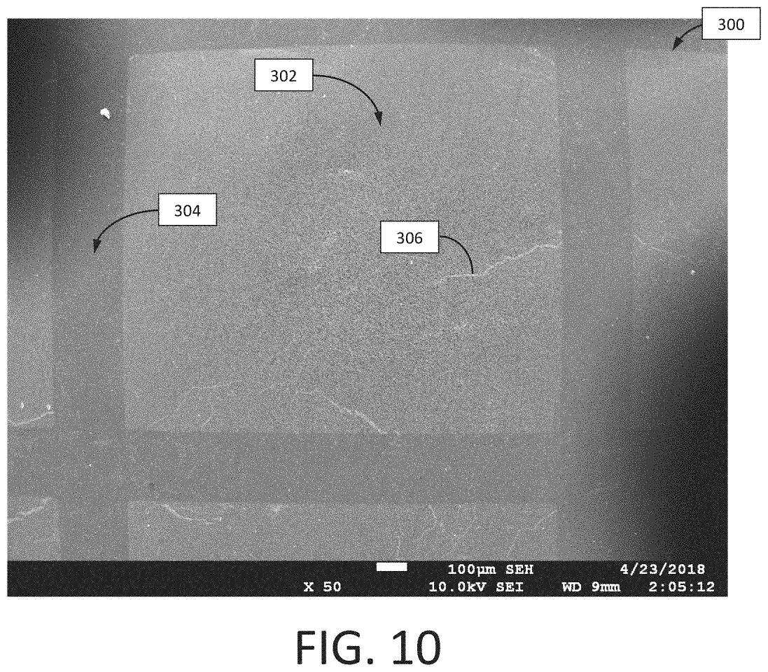

FIG. 10 shows an image of an example ultra-thin, highly porous membrane 300 fabricated according to the processes described above. Specifically, the membrane 300 is magnified fifty times in FIG. 1. As shown in FIG. 1, and similar to the membrane 100 described above, the membrane 300 includes regions 302 that were left uncovered during the track-etching process and thus include a large number of pores. The membrane 300 also includes regions 304 that were covered with a square grid mask (e.g., a metal mesh) during the track-etching process and are thus non-porous. Additionally, the membrane 300 is covered with a graphene film that again is indirectly observable at lower magnifications though microtears 306 in the graphene film. In some embodiments, the graphene film is bonded to the membrane 300 through van der Waals forces.

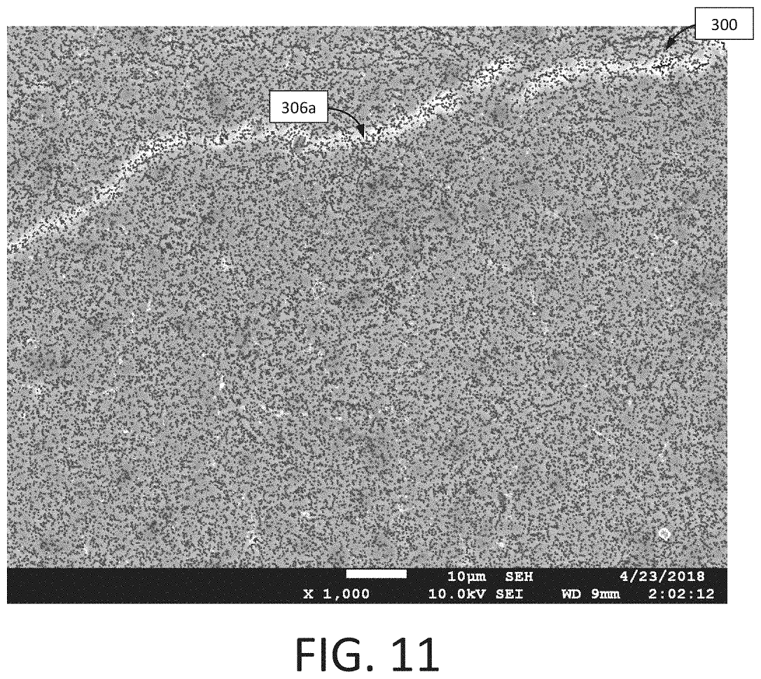

FIG. 11 shows another image of the example membrane 300, specifically, where the membrane 300 is magnified 1,000 times. A microtear 306a in the graphene film may be observed in FIG. 11. While the graphene film covers the majority of the pores observable in FIG. 11, the pores underneath the microtear 306a are uncovered. This can be observed in the brightness difference between the pores underneath the graphene film, which appear gray, and the pores underneath the microtear 306a, which appear a darker gray or even black.

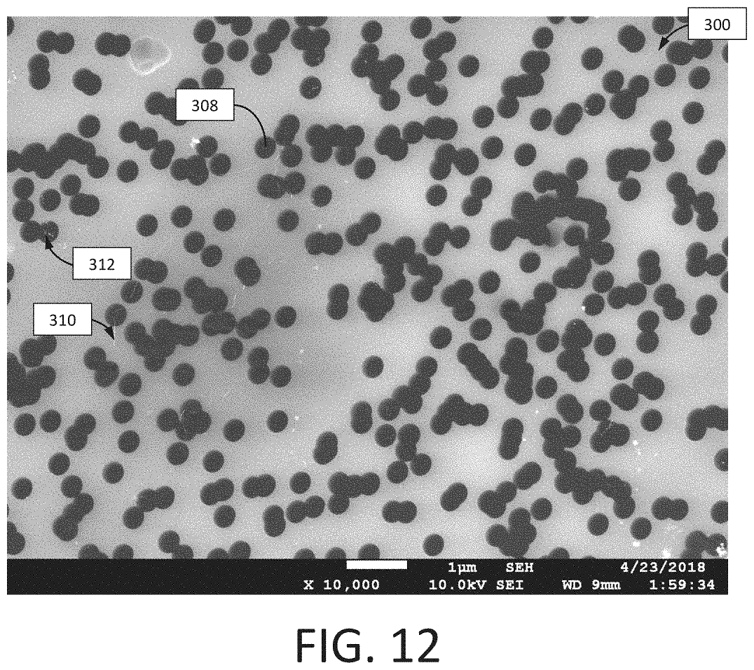

FIG. 12 shows another image of the example membrane 300, specifically, where the membrane 300 is magnified 10,000 times. As shown in FIG. 12, the individual pores 308 of the porous regions 302 can be seen at this magnification. Similar to FIG. 2, which shows the uncovered membrane 100 at the same magnitude, the track etching process described above may create a membrane 300 with well-defined, non-tortuous pores 308, although some of the pores 308 may overlap each other due to the random nature of the irradiation process. Additionally, further features of the graphene film may be observed at this magnification. As may be seen in FIG. 12, the graphene film includes wrinkles 310 as well as small nanoparticles 312 contaminating the graphene film, which may be suspended over the pores 308 by the graphene film.

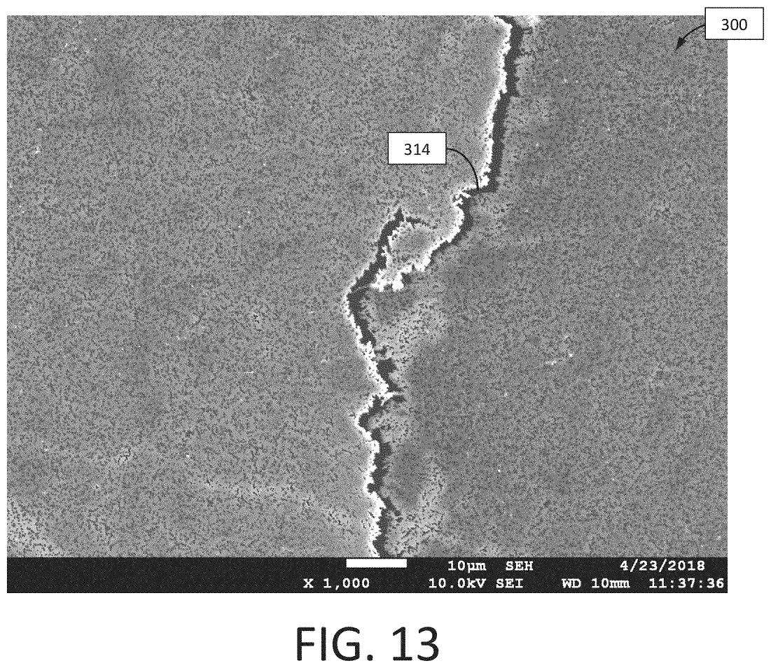

FIG. 13 shows another image of the example membrane 300, specifically, where the membrane 300 has been imaged at 1,000 times magnification similar to FIG. 11. However, unlike the membrane 300 shown in FIG. 11, a tear 314 has been introduced into the membrane 300 in FIG. 13 to illustrate the features of the membrane 300.

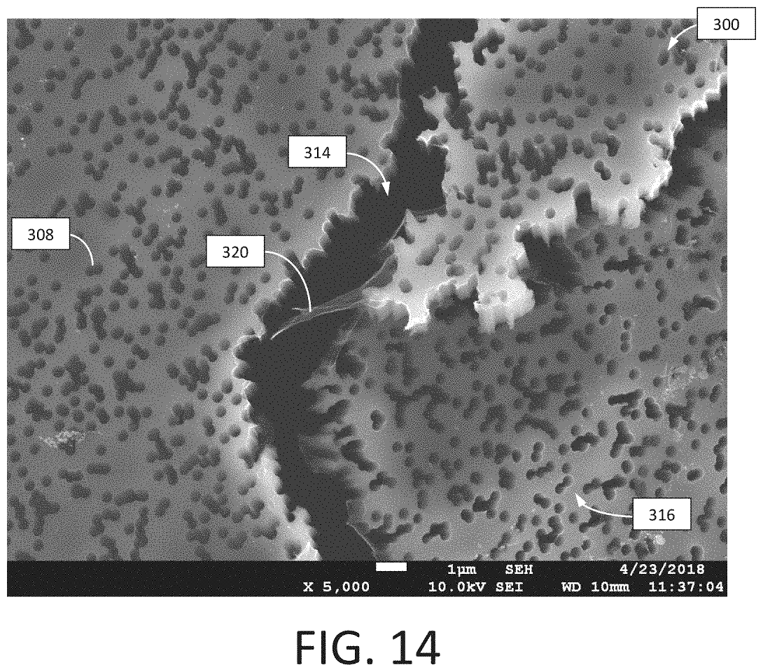

FIG. 14 shows another image of the example membrane 300 along the tear 314. Specifically, the image of FIG. 14 has been taken at 5,000 times magnification. The image of FIG. 14 includes sections 316 covered by the graphene film. Additionally, a tendril 320 of the graphene film may be observed suspended over the tear 314.

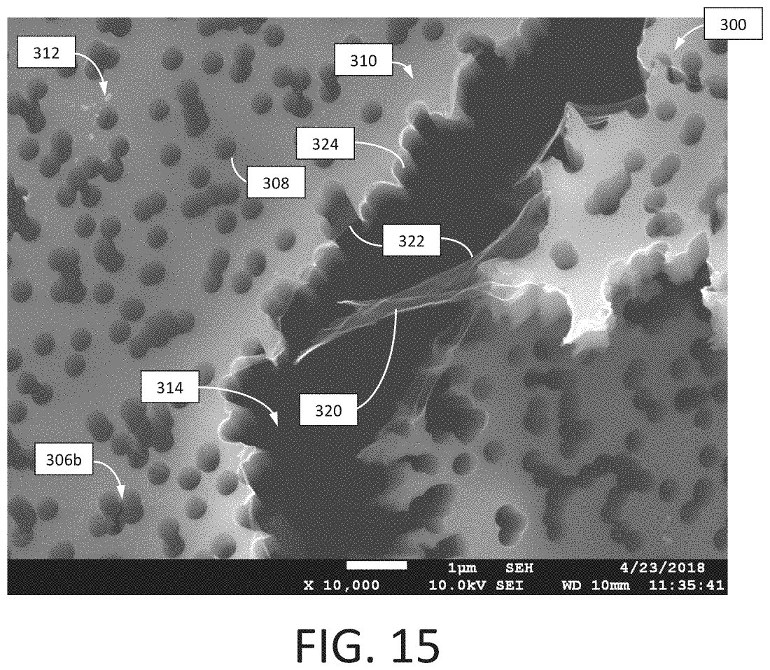

FIG. 15 shows another image of the example membrane 300 along the tear 314 and taken at 10,000 times magnification. The features of the graphene film are further observable at this magnification. Wrinkles 310 and nanoparticles 312 suspended in the graphene film may be observed in FIG. 15, as well as a microtear 306b in the graphene. Additionally, the tendril 320 of graphene film and edges 322 of the graphene film are further shown in FIG. 15. Cross-sections 324 of the pores 308 are also shown along the tear 314 in the membrane 300.

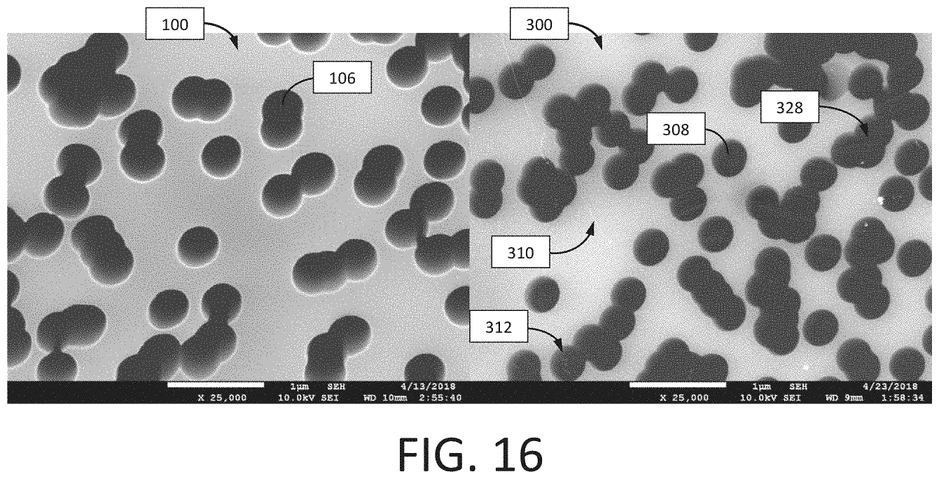

FIG. 16 shows an image of the uncovered example membrane 100 compared with an image of the example membrane 300, which is covered with a graphene film. Both images have been taken at 25,000 times magnification. The presence of the graphene film may be confirmed in the image of the membrane 300 by comparing the uncovered pores 106 and the covered pores 308. In the image of the uncovered membrane 100, the pores 106 are shown as clearer and darker, while the pores 308 in the image of the covered membrane 300 are shown as grayer and somewhat less distinct. Additionally, wrinkles 310 and nanoparticles 312 suspended by the graphene film over a substrate pore 308 may be observed in the image of the covered membrane 300. Undulations 328 in the graphene film may also be observed over some of the pores 308.

In some embodiments, the presence of a non-porous graphene film on a membrane, such as the membrane 200 or membrane 300, may alternatively be verified using a pressurized gas or aqueous test on a covered membrane versus an uncovered membrane. Because the graphene film is impermeable unless it is perforated or has defects, the permeability of the graphene-coated membrane may be dramatically reduced when compared to the uncoated membrane. For example, the permeability of the graphene-coated membrane may be reduced by 95% or more compared to the uncoated substrate, prior to the introduction of nanoporosity in the graphene coating.

In some embodiments, substrates or processes can be further modified to incorporate any number of variations, alterations, substitutions or equivalent arrangements not heretofore described, but which are commensurate with the spirit and scope of some embodiments. Such variations, alterations, substitutions include, but are not limited to those described in U.S. patent application Ser. No. 15/099,588, the entire disclosure of which is incorporated herein in its entirety by reference. Accordingly, the enclosures and methods are not limited by the foregoing description.

Specific names of compounds are intended to be exemplary, as it is known that one of ordinary skill in the art can name the same compounds differently. When a compound is described such that a particular isomer or enantiomer of the compound is not specified, for example, in a formula or in a chemical name, that description is intended to include each isomer and enantiomer of the compound described individually or in any combination. One of ordinary skill in the art will appreciate that processes, device elements, starting materials and synthetic methods other than those specifically exemplified can be employed in the practice of the processes herein without resort to undue experimentation. All art-known functional equivalents, of any such methods, processes, device elements, starting materials and synthetic methods are intended to be included herein. Whenever a range is given in the specification, for example, a temperature range, a distance range, an angle range, a time range, or a composition range, all intermediate ranges and subranges, as well as all individual values included in the ranges given are intended to be included herein. When a Markush group or other grouping is used, all individual members of the group and all combinations and subcombinations possible of the group are intended to be individually included herein.

“About” will be understood by persons of ordinary skill in the art and will vary to some extent depending upon the context in which it is used. If there are uses of the term which are not clear to persons of ordinary skill in the art, given the context in which it is used, about will mean up to plus or minus 10% of the particular term. It is to be understood that all numerical values, including ranges, include the term “about” preceding the numerical value or range, although not explicitly stated.

The terms and expressions which have been employed are used as terms of description and not of limitation, and there is no intention in the use of such terms and expressions of excluding any equivalents of the features shown and described or portions thereof, but it is recognized that various modifications are possible within the scope of some embodiments. Thus, it should be understood that although some embodiments have been specifically disclosed, modification and variation of the concepts may be resorted to by those skilled in the art, and that such modifications and variations are considered to be within the scope of the claims.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the teachings in this application (for example, a reference that is partially inconsistent is incorporated by reference except for the partially inconsistent portion of the reference).

All patents and publications mentioned in the specification are indicative of the levels of skill of those skilled in the art to which the disclosure pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

What is claimed is:

1. A method for producing a modified substrate, comprising:
providing a polymer substrate that is 5 microns or less in thickness;
ion tracking the substrate, the ion tracking including controlling a flux of ions passing through the substrate to achieve a desired pore density;
etching the tracked substrate with an etchant to produce a plurality of pores in the substrate, the etching including controlling properties of the etching to achieve a desired pore size; and
using the track-edged substrate as a support substrate for at least one of a single-layer graphene film, a multi-layer graphene film, a stack of graphene films, a nanostructure of graphene flakes, or a nanostructure of graphene platelets;
wherein the track-etching of the substrate creates a 10% or more porosity in the substrate.

2. The method of claim 1, wherein providing the substrate comprises providing a non-porous polymer substrate that is 3 microns or less in thickness.

3. The method of claim 1, wherein providing the substrate comprises providing one of a polycarbonate, a polyvinylidene fluroride, a polyimide, a polyurethane, a polyarylate, a polyethylene terephthalate, a poly(methyl methacrylate), or a polypropylene.

4. The method of claim 1, wherein the track-etching of the substrate creates a 10 to 35% porosity in the substrate.

5. The method of claim 1, wherein the track-etching of the substrate creates a nominal pore diameter of 10 to 2000 nm in the substrate.

6. The method of claim 1, wherein the track-etching of the substrate creates a pore density of 1×10⁷ to 1×10¹⁰ pores per cm² in the substrate.

7. The method of claim 1, wherein ion tracking the substrate comprises covering at least a part of a surface of the substrate with an ion-absorbing mask such that non-porous regions are maintained in the substrate underneath the mask; and
wherein ion tracking the substrate further comprises selecting the mask to produce a desired pattern of porous and non-porous regions in the substrate.

8. The method of claim 7, wherein selecting the mask comprises selecting a mask configured to provide rip-stop properties to the substrate.

9. The method of claim 1, wherein using the track-edged substrate as a support substrate comprises using the track-edged substrate as a support substrate for a stack of graphene films, the method further comprising independently stacking the graphene films on the substrate.

10. A membrane, comprising:
a two-dimensional material, a multi-layer stack or nanostructure of two-dimensional materials, a multi-layer stack or nanostructure of thin films, or a combination thereof, wherein the two-dimensional material, stack, nanostructure, or combination comprises graphene or a graphene-based material; and
a support substrate onto which the two-dimensional material, stack, nanostructure, or combination is adhered, the support substrate comprising a plurality of track-etched pores;
wherein the support substrate is 5 microns or less in thickness and has at least a 10% porosity from the track-etched pores.

11. The membrane of claim 10, wherein the support substrate is one of a polycarbonate, a polyvinylidene fluroride, a polyimide, a polyethylene terephthalate, a polyurethane, a polyarylate, a poly(methyl methacrylate), or a polypropylene.

12. The membrane of claim 10 comprising the two-dimensional material, wherein the two-dimensional material is a single-layer graphene film, a multi-layer graphene film, a stack of graphene films, a nanostructure of graphene flakes, or a nanostructure of graphene platelets.

13. The membrane of claim 12, wherein the two-dimensional material is a stack of graphene films, and wherein the graphene films are independently stacked on the support substrate.

14. The membrane of claim 10, wherein the support substrate has a 10 to 35% porosity.

15. The membrane of claim 10, wherein the support substrate has a pore density of 1×10⁷ to 1×10¹⁰ pores per cm².

16. The membrane of claim 10, further comprising a support mesh, screen, or other permeable structure onto which the support substrate is layered.

17. A high-selectivity filtration membrane, comprising:
a porous membrane comprising a plurality of track-etched pores;
wherein the membrane is 5 microns or less in thickness and has at least a 10% porosity from the track-etched pores;
wherein the track-etched pores are highly selective in filtering a desired particle size; and
wherein the porous membrane is a support substrate for at least one of a single-layer graphene film, a multi-layer graphene film, a stack of graphene films, a nanostructure of graphene flakes, or a nanostructure of graphene platelets.

18. The filter of claim 17, wherein the membrane is one of a polycarbonate, a polyvinylidene fluroride, a polyimide, a polyurethane, a polyarylate, a polyethylene terephthalate, a poly(methyl methacrylate), or a polypropylene.

19. The filter of claim 17, wherein the membrane has a 10% to 35% porosity.

20. The filter of claim 17, wherein the desired particle size is selected from 10 nm to 10,000 nm.
